(19) United States
(12) Patent Application Publication
(10) Pub. No.: US 2022/0367970 A1
(43) Pub. Date: Nov. 17, 2022

(54) BATTERY PACK

(71) Applicant: SK On Co., Ltd., Seoul (KR)

(72) Inventors: Hae Ryong JEON, Daejeon (KR); Seo Roh RHEE, Daejeon (KR)

(21) Appl. No.: 17/743,143

(22) Filed: May 12, 2022

(30) Foreign Application Priority Data
May 14, 2021 (KR) 10-2021-0062616

(51) Int. Cl. H01M 50/383; H01M 50/35

(52) U.S. Cl. CPC H01M 50/383; H01M 50/35

(57) ABSTRACT

A battery pack includes a plurality of battery modules, a case accommodating the plurality of battery modules therein and having at least one vent hole for discharging a gas formed therein to the outside, and an non-flammable member coupled to the vent hole and blocking movement of flames, wherein the non-flammable member includes a pipe-shaped body part coupled to the case to extend a gas discharge path and a flame blocking portion disposed inside the body part to lower a temperature of gas or flames passing through the inside of the body part.

### CROSS-REFERENCE TO RELATED APPLICATION

This application claims benefit of priority to Korean Patent Application No. 10-2021-0062616 filed on May 14, 2021 in the Korean Intellectual Property Office, the disclosure of which is incorporated herein by reference in its entirety.

### BACKGROUND

### 1. Field

The present disclosure relates to a battery pack, and more particularly, to a method for improving safety of a battery pack.

### 2. Description of Related Art

Recently, secondary batteries have been widely used not only in small devices such as portable electronic devices, but also in medium and large devices such as automobiles and power storage devices. In the case of such medium and large devices, a battery module or a battery pack in which a plurality of battery cells are combined is mounted to increase battery capacity and power.

However, in a battery device in which a plurality of battery cells are combined as described above, when at least one of the plurality of battery cells ignites or explodes due to thermal runaway, heat or flames may be transferred to an adjacent battery cell, thereby causing a secondary explosion. Therefore, there is a demand for a battery device capable of preventing secondary ignition or explosion.

### SUMMARY

One aspect of the present disclosure is to prevent or minimize discharge of flames or high-temperature gas occurring inside a battery pack to the outside of the battery pack.

According to another aspect of the present disclosure, a battery pack includes a plurality of battery modules, a case accommodating the plurality of battery modules therein and having at least one vent hole for discharging a gas formed therein to the outside, and an non-flammable member coupled to the vent hole, wherein the non-flammable member includes a body part coupled to the case to extend a gas discharge path and a flame blocking portion disposed inside the body part to lower a temperature of gas or flames passing through the inside of the body part and through the flame blocking portion.

An internal space of the body part may include a first opening coupled to the vent hole and a second opening spaced apart from the first opening, and the flame blocking portion may have a plurality of flow paths through which the gas formed in the case is introduced from the first opening and moves toward the second opening.

The flame blocking portion may be formed by laminating a second sheet member on a first sheet member and then winding the first sheet member and the second sheet member together, and the plurality of flow paths may be formed between the first sheet member and the second sheet member.

The first sheet member may have a flat strip shape, and the second sheet member may have a strip shape in which a plurality of valleys and a plurality of ridges are repeatedly arranged in a longitudinal direction.

The flame blocking portion may have a plurality of irregular holes therein, and the plurality of holes may be connected to each other to form the flow path.

The flame blocking portion may be formed of a material including at least one of brass, bronze, copper, stainless steel, and aluminum.

The non-flammable member may further include a blocking film coupled to the body part in a form to block the second opening.

The blocking film may allow gas generated inside the case to pass therethrough and may block a liquid or dust from being introduced into the case from the outside of the case prior to the gas or flames passing through the inside of the body part and through the flame blocking portion.

The first opening of the body part may be inserted into the vent hole and screwed to the case.

The body part may include a flange portion extending from the side of the first opening in an outer diameter direction, and the body part may be fastened to the case through a fastening member passing through the flange portion and the case.

The body part may have a pipe shape.

An overall cross-sectional area of the plurality of flow paths through which the gas is discharged in the non-flammable member may be 0.2 to 1.0 times a cross-sectional area of the first opening through which the gas is introduced.

The flame blocking portion may include between 2 and 100 flow paths.

The flame blocking portion may have 20 or less flow paths.

The non-flammable member may satisfy Equation 1 below in relation to a total cross-sectional area of the flow path:

0.2A₁≤NA₂≤A₁ (Equation 1)

Here, A₁ is a cross-sectional area of the first opening, A₂ is a cross-sectional area of each flow path, and N is a number of the flow paths.

The flame blocking portion may satisfy Equation 2 below in relation to the number N of the flow paths:

2≤N≤100. (Equation 2)

According to another aspect of the present disclosure, a battery pack accommodating a plurality of battery modules therein, includes at least one vent hole in a wall of a case for discharging a gas formed therein to the outside and at least one non-flammable member disposed on the wall, coupled to the vent hole, and comprising a body part, and a flame blocking portion disposed inside the body part and comprising at least one flow path having an inlet cross-sectional area closer to the at least one vent hole that is larger than an outlet cross-sectional area near an exit from the flame blocking portion.

the at least one non-flammable member may include multiple non-flammable members, the at least one vent hole may include multiple vent holes disposed along the wall of the case, and the multiple non-flammable members may be coupled to the multiple vent holes and may be in communication with passages between the plurality of battery modules.

A temperature of gas or flames passing through the at least one flow path may be reduced.

The gas or flames passing through the at least one flow path may restrict oxygen from entering into the case.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view schematically illustrating a battery pack according to one embodiment in the present disclosure;

FIG. 2 is a partially exploded perspective view of FIG. 1;

FIG. 3 is a cross-sectional view taken along line I-I′ of FIG. 2;

FIG. 4 is a perspective view schematically illustrating a flame blocking portion shown in FIG. 3;

FIG. 5 is a perspective view schematically illustrating a flame blocking portion according to another embodiment in the present disclosure;

FIG. 6 is a partial cross-sectional view of a flame blocking portion according to still another embodiment in the present disclosure; and

FIGS. 7 and 8 are cross-sectional views of a battery pack according to yet another embodiment in the present disclosure, respectively.

### DETAILED DESCRIPTION

Various embodiments of the present disclosure will now be described in detail with reference to the accompanying drawings.

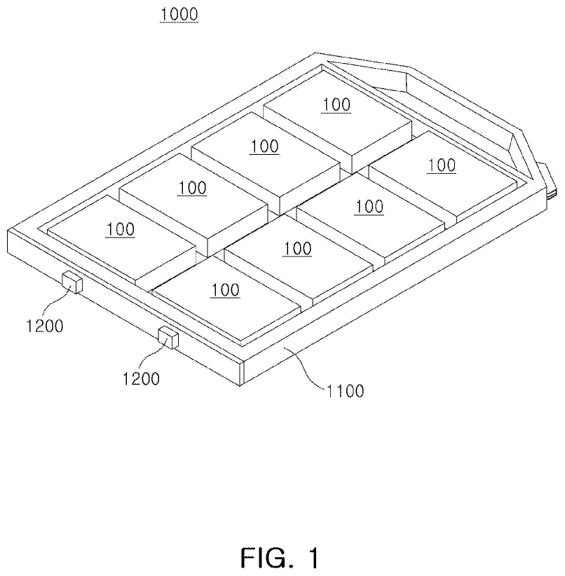

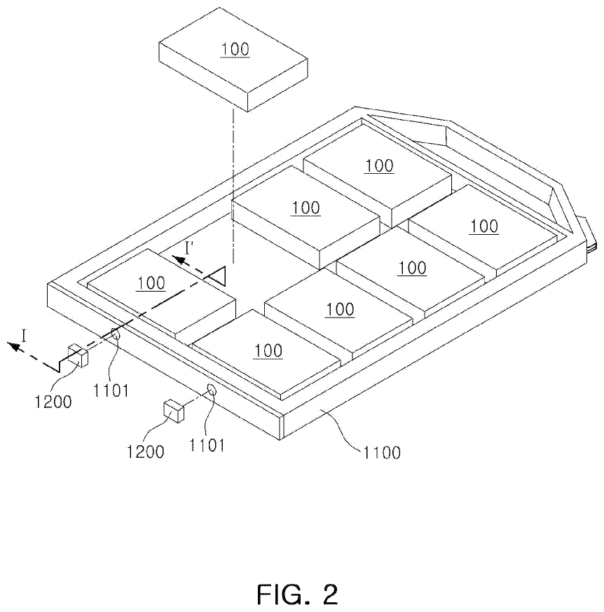

FIG. 1 is a perspective view schematically illustrating a battery pack according to one exemplary embodiment in the present disclosure, and FIG. 2 is a partially exploded perspective view of FIG. 1.

Referring to FIGS. 1 and 2, a battery pack 1000 includes a case 1100 and battery modules 100 disposed inside the case 1100. In the case of FIGS. 1 and 2, the case 1100 is illustrated on lower and side surfaces (or walls) of the battery modules 100 for convenience of explanation, but the case 1100 may be provided in a form that surrounds the entire battery modules 100.

As shown in FIG. 2, the case 1100 may include a vent hole 1101 discharging flames or gas occurring inside the battery pack 1000 to the outside of the battery pack 1000.

Referring to FIG. 2, two circular vent holes 1101 are provided in the case 1100, but this is only an example, and a cross-sectional shape, arrangement position, number, arrangement, etc. of the vent holes 1101 may be changed as needed.

The battery pack 1000 may include an exhaust structure therein. The exhaust structure may be used as a passage through which flames or gas discharged from the battery module 100 flows, and may be connected to the vent hole 1101. In the present embodiment, the exhaust structure may be formed of a space between the battery modules 100, a space between the battery module 100 and the case 1100, or a space provided inside the case 1100. However, the present disclosure is not limited thereto.

Therefore, the flame or gas discharged from the battery module 100 may be guided to the vent hole 1101 through the exhaust structure, and finally discharged to the outside of the case 1100.

In this case, if the flame is directly erupted to the outside of the case 1100 or if a temperature of the erupted gas is very high, the battery pack 1000 and neighboring components may be damaged.

Accordingly, the battery pack 1000 of the present embodiment may include at least one non-flammable member 1200 coupled to the vent hole 1101. The non-flammable member 1200 may suppress or minimize a spurt of flames or high-temperature gas to the outside of the battery pack and thereby suppress the spread of fire to other neighboring battery packs 1000 or to the surrounding area.

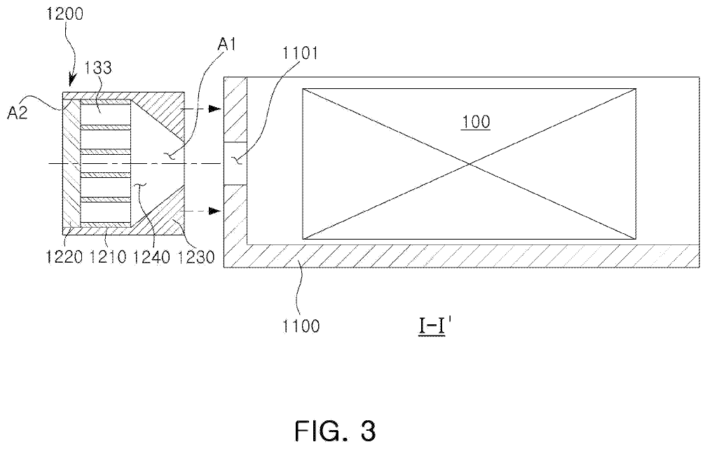

FIG. 3 is a cross-sectional view taken along line I-I′ of FIG. 2, and with reference to FIG. 3, the non-flammable member 1200 of the present embodiment may include a body part 1230 forming an overall appearance and a flame blocking portion 1210 and a blocking film 1220 disposed inside the body part 1230 to block the inflow of liquid or dust from the outside of the case 1100.

The body part 1230 may include an internal space 1240 in which the flame blocking portion 1210 is accommodated. The internal space 1240 of the body part 1230 may have both ends connected to the outside, and thus the body part 1230 may have a pipe shape with both ends open.

The internal space 1240 of the body part 1230 may include a first opening A1 coupled to the case 1100 and a second opening A2 disposed on the opposite side of the first opening A1. The first opening A1 and the second opening A2 may be spaced apart from each other and have different sizes. However, the present disclosure is not limited thereto.

The first opening A1 may be connected to the vent hole 1101 of the case 1100. That is, the exhaust structure of the battery pack 1000 may be coupled to the internal space 1240 of the body part 1230 through the vent hole 1101 and the first opening A1, and thus the internal space 1240 of the body part 1230 may be formed to extend a discharge path of a gas of the battery pack 1000.

Accordingly, the gas occurring in the case 1100 may move to the vent hole 1101 along the exhaust structure, may flow into the internal space 1240 of the non-flammable member 1200 through the first opening A1, and then may be discharged to the outside through the second opening A2.

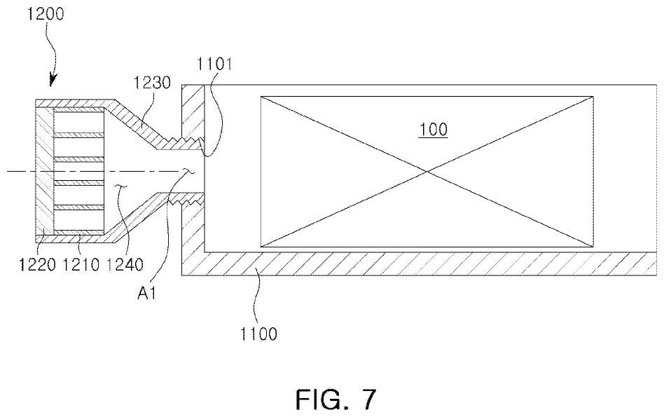

To this end, the first opening A1 of the present embodiment may be formed to have the same size as that of the vent hole 1101. However, the present disclosure is not limited thereto, and the first opening A1 and the vent hole 1101 may have different sizes as needed, as in an embodiment shown in FIG. 7.

When flames occur inside the case 1100, the flame may be introduced into the internal space 1240 of the body part 1230. Therefore, the body part 1230 may be formed of a material having corrosion resistance and withstanding pressure and temperature caused by an explosion or fire inside the battery pack 1000. For example, the body part 1230 may be formed of a metal material having heat resistance, such as stainless steel, cast iron, or aluminum.

The flame blocking portion 1210 may be disposed in the internal space of the body part 1230 to lower a temperature of the gas or flames passing through the body part 1230. In addition, even if the flame is introduced into the first opening A1 side, spurt of the flame toward the second opening A2 may be blocked.

A shape of the flame blocking portion 1210 may be formed to correspond to a shape of the internal space 1240 of the body part 1230. For example, when the internal space 1240 of the body part 1230 has a cylindrical shape, a cross-section of the flame blocking portion 1210 may be formed in a circular shape. In addition, when the internal space 1240 of the body part 1230 has a polygonal column shape, a cross-section of the flame blocking portion 1210 may also be formed in a polygonal shape.

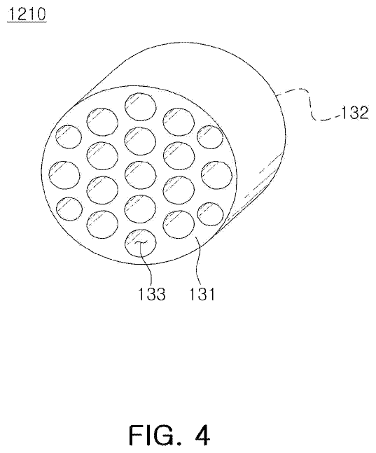

FIG. 4 is a perspective view schematically illustrating the flame blocking portion 1210 according to FIG. 3.

Referring also to FIG. 4, the flame blocking portion 1210 of the present embodiment may be formed to have a size to completely occupy the internal space 1240 of the body part 1230. Therefore, a cross-section (or an outer diameter) of the flame blocking portion 1210 may be formed to have the same size as that of a cross-section (or an inner diameter) of the internal space 1240.

The flame blocking portion 1210 may have a thickness of a certain size, and a plurality of flow paths 133 may be provided in a thickness direction. Here, the thickness direction of the flame blocking portion 1210 may be defined as a direction in which a gas flows in the internal space 1240 of the body part 1230. Accordingly, gas introduced into the internal space 1240 of the non-flammable member 1200 through the first opening A1 may move along the flow path 133 of the flame blocking portion 1210 and then may be discharged to the outside through the second opening A2.

In the present embodiment, the flow path 133 may be formed as a hole passing through one surface 131 and the other surface 132 of the flame blocking portion 1210, and a plurality of flow paths 133 may be arranged to be parallel to each other. The plurality of flow paths 133 may or may not communicate with each other.

The flow path 133 of the present embodiment may have a very small cross-section (or diameter). Accordingly, the gas may be easily discharged to the outside through the flow path 133, and a flow of the flame into the flow path 133 may be blocked or the flow may be dispersed as much as possible.

The flame blocking portion 1210 of the present embodiment may absorb thermal energy of the flame or gas, while the flame or gas passes through the elongated flow path 133. For example, in the process in which the gas introduced from the battery pack 1000 passes through the flow path 133, heat of the gas may be discharged to the outside through partition wall(s) separating the flow paths 133 of the flame blocking portion 1210, and thus, in this case, the gas may be cooled to below an ignition temperature. Similarly, in the process in which the flame introduced from the battery pack 1000 passes through the flow path 133, heat is discharged to the outside by the flame blocking portion 1210, so that a temperature of the flame itself may be lowered below an ignition temperature to extinguish the flame.

To this end, the flame blocking portion 1210 of the present embodiment may be formed of a material having high thermal conductivity. For example, the flame blocking portion 1210 may include one or more metal materials such as brass, bronze, copper, stainless steel, and aluminum. For example, the flame blocking portion 1210 may be formed of a material having a thermal conductivity of 5 W/mK or more. In addition, the flame blocking portion 1210 may include a fire resistant material.

In addition, in the non-flammable member 1200 of the present exemplary embodiment, a cross-sectional area (hereinafter, an outlet cross-sectional area) of the entire number of flow paths forming a gas outlet may be formed to be smaller than or equal to a cross-sectional area (hereinafter, an inlet cross-sectional area) of the first opening A1 forming a gas inlet of the non-flammable member 1200.

When the inlet cross-sectional area is formed to be larger than the outlet cross-sectional area, the gas occurring in the internal space of the battery pack 1000 may be more easily discharged to the outside of the case 1100 as compared to a case in which the inlet cross-sectional area and the outlet cross-sectional area are maintained to be the same.

Accordingly, when flames occur inside the battery pack 1000 and gas is discharged, an increase in pressure inside the battery pack 1000 may be limited. In addition, since the outlet cross-sectional area is formed to be smaller than the inlet cross-sectional area, it may be difficult for external air of the case 1100 to flow into the internal space of the case 1100 through the non-flammable member 1200. Accordingly, the inflow of external air (oxygen) may be effectively blocked, without excessively increasing the pressure inside the battery pack 1000.

More specifically, in the non-flammable member 1200 of the present embodiment, the outlet cross-sectional area may be 0.2 to 1.0 times the inlet cross-sectional area. Accordingly, the non-flammable member 1200 of the present embodiment may satisfy Equation 1 below in relation to the cross-sectional area of the flow path 133.

0.2A₁≤NA₂≤A₁ (Equation 1)

Here, A₁ is the cross-sectional area of the first opening A1, A₂ is the cross-sectional area of each flow path 133, and N is the number of flow paths 133. Accordingly, A₁ may mean the inlet cross-sectional area, and NA₂ may mean the outlet cross-sectional area.

Equation 1 may be applied to a case in which the cross-sectional area of each flow path 133 is the same. Therefore, when the cross-sectional areas of the respective flow paths 133 are formed to be different, NA₂ may be substituted with the sum of the cross-sectional areas of the respective flow paths 133.

If the outlet cross-sectional area is less than 0.2 times the inlet cross-sectional area, the outlet cross-sectional area may be excessively small, so that the gas in the internal space of the battery pack 1000 may not be smoothly discharged to the outside, and thus the pressure inside the battery pack 1000 may be excessively increased.

Conversely, if the outlet cross-sectional area is larger than the inlet cross-sectional area, external air and oxygen contained therein may flow into the internal space of the case 1100. The inflow of oxygen may react with the flame to cause an explosion of the battery pack 1000 or rapid propagation of the flame inside the battery pack 1000.

Meanwhile, if the outlet cross-sectional area is smaller than the inlet cross-sectional area as in the present embodiment, since the gas should be discharged to the outlet having a smaller cross-sectional area than the inlet, the internal pressure of the case may be increased. Accordingly, a flow of the gas discharged to the outside of the non-flammable member is increased due to the increased pressure, so that a gas discharge rate may be increased.

In this case, since the gas may be ejected to the outside through the entire outlet cross-sectional area due to the pressure described above, the inflow of external air into the case through the outlet may be suppressed.

Meanwhile, when the outlet cross-sectional area and the inlet cross-sectional area are the same, the flow of gas may be reduced, and the effect described above may be reduced. However, in the non-flammable member 1200 of the present embodiment, since the gas is dispersed and discharged into the plurality of flow paths 133, the inflow of external air may be suppressed compared to the case in which the outlet is formed as one opening. Therefore, even if the outlet cross-sectional area and the inlet cross-sectional area are the same, the effect described above may be provided.

Meanwhile, if the flame blocking portion 1210 has an excessively large number of flow passages 133, a thickness of the partition wall disposed between the flow paths 133 may be reduced, and thus a cooling effect through the partition wall may be reduced. For example, if a hundred (100) or more flow paths 133 are formed, a difference in the cooling effect described above may not be large and the difficulty of manufacturing is increased.

Accordingly, in the present embodiment, the number of flow paths 133 provided in the flame blocking portion 1210 may be between 2 and 100. Accordingly, the flame blocking portion 1210 may satisfy Equation 2 below with respect to the number N of the flow paths 133.

2≤N≤100 (Equation 2)

Specifically, the flame blocking portion 1210 of the present embodiment may include 20 or less flow paths 133, but is not limited thereto.

Meanwhile, various modifications are possible for the flame blocking portion 1210 of the present embodiment.

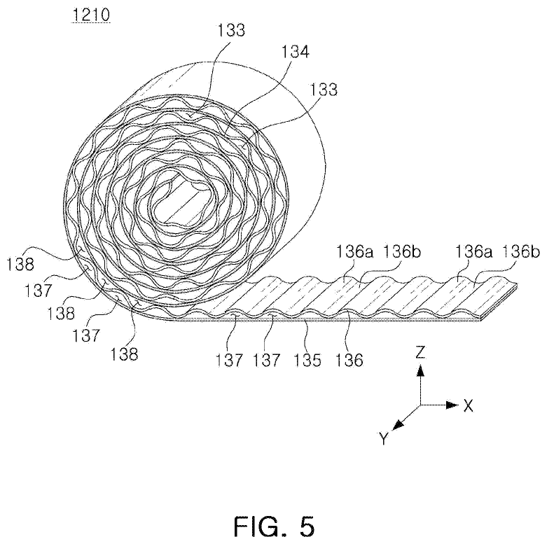

FIG. 5 is a perspective view schematically illustrating the flame blocking portion 1210 according to another embodiment in the present disclosure.

Referring to FIG. 5, the flame blocking portion 1210 of the present embodiment may include a first sheet member 135 and a second sheet member 136 laminated on the first sheet member 135. Flow paths 137 and 138 may be formed between the first sheet member 135 and the second sheet member 136. For example, the first sheet member 135 may be provided in the form of a flat strip extending in a longitudinal direction, and the second sheet member 136 may be provided in the form of a strip extending unevenly (e.g., undulating) in the longitudinal direction.

In the second sheet member 136, a plurality of ridges 136a and a plurality of valleys 136b may be repeatedly arranged in the longitudinal direction. Therefore, when the first sheet member 135 and the second sheet member 136 are coupled to each other, the first flow path 137 may be formed between the plurality of valleys 136b and the plurality of ridges 136a.

In the present embodiment, the second sheet member 136 may be formed to be curved in a sine wave shape. However, the configuration of the present disclosure is not limited thereto, and the shape of the second sheet member 136 may be variously modified as long as the plurality of flow paths 133 are formed between the first sheet member and the second sheet member. For example, the second sheet member 136 may be formed in a square wave shape or a triangular wave shape.

When the first sheet member 135 and the second sheet member 136 are wound together in a state in which the second sheet member 136 is disposed on the first sheet member 135, the flame blocking portion 1210 having a circular cross-sectional shape and having a predetermined thickness may be prepared. In this case, a second flow path 138 may be additionally formed between the first sheet member 135 and the second sheet member 136.

In the present embodiment, the flow paths 137 and 138 between the first sheet member 135 and the second sheet member 136 may be arranged such that a longitudinal direction thereof intersects a longitudinal direction of the sheet members 135 and 136. For example, as shown in FIG. 5, each of the flow paths 137 and 138 may be elongated in a direction y perpendicular to the longitudinal direction x of the sheet members 135 and 136. However, the present disclosure is not limited thereto, and the longitudinal direction of each of the flow paths 137 and 138 may be formed to have various angles with the longitudinal direction of the sheet members.

In addition, in the present embodiment, the flow paths 137 and 138 are formed in a straight shape, but the configuration of the present disclosure is not limited thereto, and the flow paths 137 and 138 may be changed in various forms as long as both ends are exposed toward the first opening A1 and the second opening A2, respectively. For example, the flow paths 137 and 138 may be formed in a curved shape or a curved linear shape.

Also, each of the flow paths 137 and 138 may be connected to other flow paths 133 inside the flame blocking portion 1210. For example, at least one through hole may be provided in the first sheet member 135 or the second sheet member 136, and two flow paths may be connected to each other through the through hole.

Meanwhile, as shown in FIG. 5, in the present embodiment, the sheet members 135 and 136 may be wound in a circular shape. However, this is only an example, and the sheet members 135 and 136 may be wound in various shapes to correspond to the shape of the internal space 1240 of the body part 1230.

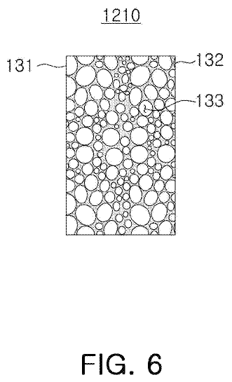

FIG. 6 is a partial cross-sectional view of the flame blocking portion 1210 according to another embodiment in the present disclosure.

Referring to FIG. 6, the flame blocking portion 1210 of the present embodiment may be formed of a porous material including irregular holes.

The irregular holes formed in the flame blocking portion 1210 may be connected to each other so that the gas flowing into the inside from one surface 131 of the flame blocking portion 1210 may be exhausted to the other surface 132 of the flame blocking portion 1210 through the irregular holes. In addition, the flame introduced into the flame blocking portion 1210 from one side of the flame blocking portion 1210 may be cooled or extinguished while passing through numerous holes.

For example, the flame blocking portion 1210 of the present embodiment may be formed in the form of a sponge or foam. However, the present disclosure is not limited thereto, and it is also possible to form the flame blocking portion 1210 by overlapping a plurality of perforated plates or mesh nets, or by overlapping a plurality of corrugated ribbons. In addition, various modifications are possible such as forming the flame blocking portion 1210 by bundling a plurality of wires.

As such, the flame blocking portion 1210 of the present disclosure has the flow path 133 and may be modified in various forms as long as it may effectively lower the temperature of the gas or flames passing through the flow path 133.

Referring back to FIG. 3, the non-flammable member 1200 according to the present embodiment may include a blocking film 1220.

The blocking film 1220 may be coupled to the body part 1230 in a form to block the second opening A2.

The blocking film 1220 (as described above) may be provided to block the inflow of liquid or dust from the outside of the case 1100 to the inside of the case 1100 through the non-flammable member 1200. To this end, the blocking film 1220 of the present embodiment may be formed of a material blocking the inflow of dust or liquid and allowing only a gas to pass therethrough.

In the present embodiment, the blocking film 1220 may be formed in the form of a sheet or a film and may be bonded to the second opening A2 of the body part 1230 or bonded to one surface of the flame blocking portion 1210 disposed to be adjacent to the second opening A2.

The blocking film 1220 may block foreign substances from the outside of the battery pack 1000 from flowing into the inside of the battery pack 1000 when the battery pack 1000 is normally operated. In addition, when flames or gas occurs inside the battery pack 1000, the blocking film 1220 may discharge the gas to the outside. In one embodiment, the blocking film 1220 may be formed of a material that becomes easily extinct at a high temperature. In this case, the blocking film 1220 may be removed by flames or a high-temperature gas. Accordingly, when flames occur inside the battery pack 1000, a decrease in gas exhaust efficiency may be prevented by the blocking film 1220.

A plurality of the non-flammable members 1200 of the present embodiment may be spaced apart and fastened to the case 1100. The non-flammable member 1200 of the present embodiment may be coupled to the case 1100 using an adhesive or through a bonding method such as welding. However, the configuration of the present disclosure is not limited thereto, and various modifications are possible as in the embodiments to be described later.

The battery pack 1000 of the present embodiment described above includes the non-flammable member 1200 coupled to the vent hole 1101. Therefore, it is possible to prevent or suppress the flame or high-temperature gas occurring inside the battery pack 1000 from being erupted to the outside of the battery module 100, and thus, even if a fire occurs in a specific battery pack 1000, the spread of the fire to other neighboring battery packs 1000 or to the surrounding area may be suppressed.

In addition, since the non-flammable member 1200 of the present embodiment is coupled to the case 1100 from the outside of the battery pack 1000, the non-flammable member 1200 may be easily applied to the conventional battery pack 1000 having the vent hole 1101.

Meanwhile, the battery pack of the present disclosure is not limited to the embodiment described above and various modifications are possible.

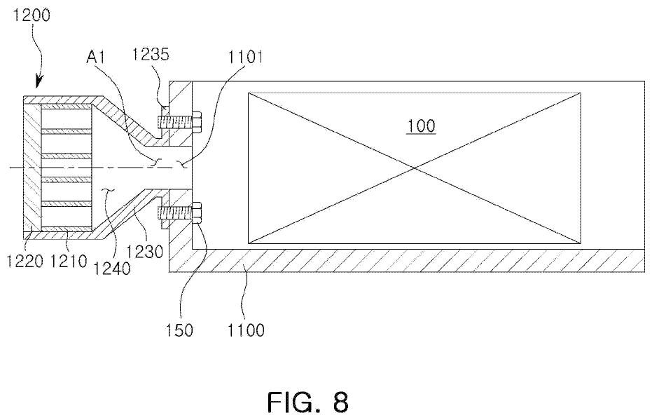

FIGS. 7 and 8 are cross-sectional views of the battery pack 1000 according to another embodiment in the present disclosure, respectively, illustrating a cross-sectional view corresponding to FIG. 3.

Referring to FIG. 7, in the non-flammable member of the present embodiment, the side of the first opening A1 may be screwed to the vent hole 1101 of the case 1100. To this end, a thread may be formed on an outer peripheral surface of the body part 1230 on the side of the first opening A1. Also, a thread may be formed on an inner circumferential surface of the vent hole 1101.

In this case, a size of the first opening A1 may be smaller than a size of the vent hole 1101.

Meanwhile, in the present embodiment, a case in which the non-flammable member 1200 is inserted into the vent hole 1101 is taken as an example, but the vent hole 1101 may be formed to protrude to the outside, and a protruding portion may be inserted into the internal space 1240 of the non-flammable member 1200 to be screwed.

In addition, although the screw coupling is taken as an example in the present embodiment, various modification may be possible such that the first opening A1 side of the non-flammable member 1200 may be inserted into the vent hole 1101 to be coupled by a fitting method, or may be configured to be rotatably coupled in a manner similar to a Bayonet Neill-Concelman (BNC) connector.

Referring to FIG. 8, the non-flammable member according to the present embodiment may include a flange portion 1235 extending in an outer diameter direction from the side of the first opening A1 of the body part 1230.

The flange portion 1235 may be configured so that one surface is in surface contact with the case 1100, and thus the non-flammable member may be fastened to the case 1100 through a fastening member 150 such as a bolt penetrating through the flange portion 1235 and the case 1100.

As such, the non-flammable member of the present disclosure may be fastened to the case 1100 in various manners as needed.

In the above, the configuration and features of the present disclosure have been described based on the embodiments according to the present disclosure, but the present disclosure is not limited thereto, and various changes or modifications may be made within the spirit and scope of the present disclosure as being apparent to those skilled in the art to which the present disclosure pertains, and therefore, such changes or modifications are intended to fall within the scope of the present disclosure.

Also, each of the embodiments may be implemented in combination with each other. For example, it is also possible to configure the body to include two or more flame blocking portions. As the two or more flame blocking portions, flame blocking portions of different embodiments may be used in combination.

As set forth above, according to the various embodiments of the present disclosure, since spurt of flames or high-temperature gas occurring inside the battery pack to the outside of the battery pack is prevented or minimized, an occurrence of a secondary explosion, etc. may be prevented.

While various embodiments have been shown and described above, it will be apparent to those skilled in the art that modifications and variations could be made without departing from the scope of the present disclosure as defined by the appended claims.

What is claimed is:

1. A battery pack comprising:
a plurality of battery modules;
a case accommodating the plurality of battery modules therein and having at least one vent hole for discharging a gas formed therein to the outside; and
a non-flammable member coupled to the vent hole,
wherein the non-flammable member includes a body part coupled to the case to extend a gas discharge path and a flame blocking portion disposed inside the body part to lower a temperature of gas or flames passing through the inside of the body part and through the flame blocking portion.

2. The battery pack of claim 1, wherein an internal space of the body part includes a first opening coupled to the vent hole and a second opening spaced apart from the first opening, and the flame blocking portion has a plurality of flow paths through which the gas formed in the case is introduced from the first opening and moves toward the second opening.

3. The battery pack of claim 2, wherein the flame blocking portion is formed by laminating a second sheet member on a first sheet member and then winding the first sheet member and the second sheet member together, and the plurality of flow paths are formed between the first sheet member and the second sheet member.

4. The battery pack of claim 3, wherein the first sheet member has a flat strip shape, and the second sheet member has a strip shape in which a plurality of valleys and a plurality of ridges are repeatedly arranged in a longitudinal direction.

5. The battery pack of claim 2, wherein the flame blocking portion has a plurality of irregular holes therein, and the plurality of holes are connected to each other to form the flow path.

6. The battery pack of claim 2, wherein the flame blocking portion is formed of a material including at least one of brass, bronze, copper, stainless steel, and aluminum.

7. The battery pack of claim 2, wherein the non-flammable member further includes a blocking film coupled to the body part in a form to block the second opening.

8. The battery pack of claim 7, wherein the blocking film allows gas generated inside the case to pass therethrough and blocks a liquid or dust from being introduced into the case from the outside of the case prior to the gas or flames passing through the inside of the body part and through the flame blocking portion.

9. The battery pack of claim 2, wherein the first opening of the body part is inserted into the vent hole and screwed to the case.

10. The battery pack of claim 2, wherein the body part includes a flange portion extending from the side of the first opening in an outer diameter direction, and the body part is fastened to the case through a fastening member passing through the flange portion and the case.

11. The battery pack of claim 1, wherein the body part has a pipe shape.

12. The battery pack of claim 2, wherein an overall cross-sectional area of the plurality of flow paths through which the gas is discharged in the non-flammable member is 0.2 to 1.0 times a cross-sectional area of the first opening through which the gas is introduced.

13. The battery pack of claim 12, wherein the flame blocking portion includes between 2 and 100 flow paths.

14. The battery pack of claim 12, wherein the flame blocking portion has 20 or less flow paths.

15. The battery pack of claim 2, wherein
the non-flammable member satisfies Equation 1 below in relation to a total cross-sectional area of the flow paths:
0.2A₁≤NA₂≤A₁ (Equation 1)
wherein A₁ is a cross-sectional area of the first opening, A₂ is a cross-sectional area of each flow path, and N is a number of the flow paths.

16. The battery pack of claim 15, wherein
the flame blocking portion satisfies Equation 2 below in relation to the number N of the flow paths:
2≤N≤100. (Equation 2)

17. A battery pack accommodating a plurality of battery modules therein, comprising:
at least one vent hole in a wall of a case for discharging a gas formed therein to the outside; and
at least one non-flammable member disposed on the wall, coupled to the vent hole, and comprising
a body part, and
a flame blocking portion disposed inside the body part and comprising at least one flow path having an inlet cross-sectional area closer to the at least one vent hole that is larger than an outlet cross-sectional area near an exit from the flame blocking portion.

18. The battery pack of claim 17, wherein
the at least one non-flammable member comprises multiple non-flammable members,
the at least one vent hole comprises multiple vent holes disposed along the wall of the case, and
the multiple non-flammable members are coupled to the multiple vent holes and are in communication with passages between the plurality of battery modules.

19. The battery pack of claim 18, wherein a temperature of gas or flames passing through the at least one flow path is reduced.

20. The battery pack of claim 19, wherein the gas or flames passing through the at least one flow path restricts oxygen from entering into the case.
